(19) United States
(12) Patent Application Publication
(10) Pub. No.: US 2003/0133401 A1
(43) Pub. Date: Jul. 17, 2003

(54) Optical storage medium

(76) Inventors: Gunther Dausmann, Erding (DE); Irina Menz, Dierdorf (DE); Zishao Yang, Erding (DE)

Correspondence Address: Rocco S Barrese, Dilworth & Barrese, 333 Earle Ovington Boulevard, Uniondale, NY, 11553, US

(21) Appl. No.: 10/182,929

(22) PCT Filed: Dec. 14, 2000
(86) PCT No.: PCT/EP00/12747

(30) Foreign Application Priority Data
Feb. 4, 2000 (DE) 100 04 870.6

(51) Int. Cl. G11B 7/24

(52) U.S. Cl. 369/275.4; 369/103; 369/53.21; 369/52.1

(57) ABSTRACT

In an optical storage medium, preferably a CD or DVD, comprising a spiral track which consists of pits following one another, a hologram is superimposed in the recording region. To achieve a great security against faking by the superimposition with the hologram, without the good recognisability of the hologram being substantially impaired on its reconstruction, the hologram is introduced at least into one information carrier, for example into the surface region of the recording region including the pit.

The invention relates to an optical storage medium, preferably a CD or DVD, comprising a spiral track which consists of pits following one another and on which a hologram is superimposed in the recording region.

Particularly CDs are objects of product piracy and the high faking rate of CDs causes substantial losses among manufacturers due to the faked products and in particular also due to the quality deficiencies of these faked products. To protect CDs from copying, usually holograms forming authentication seals are applied to the rear of the CDs or to the ring-shaped edge strip or to the inner region between which the recording region is disposed. These holograms forming authenticity features do not only have to be especially manufactured, they must also be applied with additional manufacturing steps and they can also be manufactured without problem by fakers and applied to copied CDs. There is therefore a need to connect holograms forming authenticity features to CDs in a manner such that these can be manufactured in a simple manner and furthermore provide a great protection against copying.

Such a protection against faking can be achieved in that the hologram is introduced into the recording region of the CDs in a manner such that the quality of the stored signals does not suffer thereby during reading.

A CD or a DVD is known from WO 99/13466 in whose pits a hologram has been introduced. Since the hologram is only stored in the pits, it consists of pixels depending on the length of the pits such that the recognisability of the reconstructed hologram is impaired.

It is the object of the invention to provide an optical storage medium of the kind first specified which provides great security against faking in its recording region due to superimposition with a hologram, with the hologram being characterised by good recognisability in its reconstruction.

This object is solved in accordance with the invention in that at least one hologram is introduced into at least one surface region of the recording region including the information carriers, e.g. into the surface region including the pits.

Since the surface region including the information carriers, e.g. pits, is larger than the region taken up by the information carriers, easily recognisable holograms can, for example, be introduced into a CD. The holograms forming an authenticity feature are produced in the CD master so that the CDs can be moulded from this by way of mass production in a technical injection moulding manner or also a technical stamping manner. The manufacture of the CD master with the hologram introduced into the tool requires special knowledge of the manufacturer which will not be easily available to a faker.

The authenticity features in accordance with the invention in the form of holograms cannot be realised only with CDs and DVDs, but also with all other optical storage media in a corresponding or analogue manner.

Provision is made in accordance with a preferred embodiment that the ratio of the depths of the holographic phase structure to the depths of the pits amounts to 1:5 to 1:10 and preferably to 1:6. It must be taken into account here that, for example with a structural depth of the holograms of 20 nm, a diffraction efficiency of approximately 10% is achieved. Holograms with diffraction efficiencies of approximately 2% are already easily visible to the human eye. Holographic structural depths of approximately 10 nm are preferred for the holograms to be introduced in accordance with the invention.

Provision is made in accordance with a further preferred embodiment that the hologram contains electronically readable features.

The CD master containing a hologram for the manufacture of the optical storage media in accordance with the invention can be manufactured, for example, in that a hologram is exposed into a plate coated with photoresist with a reversed image by laser light. In this connection, different exposure techniques such as a 2D technique, a 3D technique, a dot matrix technique or a holomax technique can be used. The photoresist is then developed with an alkaline developer so that a holographic surface relief is created in the photoresist with a preferred depth of, for example, 500 nm. The surface is then silver plated and an electroplated nickel casting is subsequently taken. The holographic image then appears right way round in the nickel matrix obtained and is raised over the nickel matrix. The nickel matrix then serves as the embossing matrix for a CD master from photoresist. The CD information is then produced in the surface of this photoresist in the usual photo-lithographic way in the form of pits and lands. The nickel matrix is embossed into the raised structures of the CD resist master carrying the CD information with a certain pressure, and indeed only down to a depth of 10 to 20 nm. The CD master manufactured in this manner from photoresist then has a conductive material vapour deposited on it in a usual manner and is electronically cast in nickel. A nickel matrix is manufactured in this manner which is used for the mass production of CDs in the plastic injection moulding process. The structured side of the CD is vapour coated with aluminium and then a protective lacquer forming the rear side is applied. The CD side to be read usually consists of transparent polycarbonate.

A CD master for the manufacture of CDs protected by holograms can, for example, also be manufactured in that the hologram is embossed into the still not exposed photoresist and the photoresist is subsequently exposed with the CD information in the normal manner and is further processed or in that the photoresist is exposed twice, and indeed once with the hologram and subsequently with the pit pattern to be produced, whereupon the usual further processing takes place up to the completion of the CD master suitable for casting.

With a CD, the hologram representing the security feature can be introduced into the recording region into the raised surface of the recording region which consists of the lands between the pits and the spacings between the tracks, which normally amounts to 1.6 μm.

1. An optical storage medium, preferably a CD or DVD, comprising a spiral track which consists of pits following one another and on which a hologram is superimposed in the recording region,
characterized in that
at least one hologram is introduced into one surface region of the recording region including the information carriers, e.g. into the surface region including the pits.

2. A storage medium in accordance with claim 1, wherein the ratio of the depths of the holographic phase structure to the depths of the pits amounts to 1:5 to 1:10 and preferably to 1:6.

3. A storage medium in accordance with either of claims 1 or 2, wherein the hologram contains electronically readably features.
